(19) United States
(12) Patent Application Publication
(10) Pub. No.: US 2002/0111260 A1
(43) Pub. Date: Aug. 15, 2002

(54) Rim flattener apparatus and method

(75) Inventor: Dale L. Sand, Hibertus, WI (US)

Correspondence Address: Todd A. Rathe, FOLEY & LARDNER, Firstar Center, 777 East Wisconsin Avenue, Milwaukee, WI, 53202-5367, US

(73) Assignee: Paper Machinery Corporation

(21) Appl. No.: 09/782,548

(22) Filed: Feb. 13, 2001

(51) Int. Cl. B31B 1/00

(52) U.S. Cl. 493/51

(57) ABSTRACT

A machine and a method for forming a rim of a paperboard container having a bottom and a sidewall terminating at a rim are disclosed. The machine includes a frame, a turret rotatably coupled to the frame, a plurality of circumferentially spaced pockets supported by the turret and a plurality of workstations about the turret. Each pocket includes a shell having a cavity with a mouth configured to receive the container along an axis and a first member about the cavity and including a first surface. The first surface is one of a flat surface and a concave surface and is actuatable along the axis from a retracted position below the mouth to an extended position adjacent the mouth. The plurality of workstations includes a first station and a second station. The first station has a first tool with a second surface, wherein the second surface is said one of a flat surface and a concave surface. The first tool is adapted to move along the axis so as to engage and form the paperboard rim between the first and second surfaces. The second station includes a second tool having a third surface, wherein the third surface is the other of a flat surface and a concave surface. The second station further includes a plurality of die segments about the second tool. Each segment has a fourth surface, wherein the fourth surface is the other of a flat surface and a concave surface. The die segments are adapted to move along the axis and to pivot between a closed position in which the fourth surface engages and forms a rim and an opened position.

### FIELD OF THE INVENTION

The present invention relates generally to the field of machines that form rims of containers. In particular, the present invention relates to the field of a single machine rim curling and rim flattening device.

### BACKGROUND OF THE INVENTION

Rims of containers are often curled to provide the container with a smooth and stronger upper edge. However, curled upper edges provide only a limited amount of surface area (the crown) against which the sealing panel may be secured. As a result, the curls are often flattened to provide a larger surface area against which a sealing panel may be secured. The flattened curl itself is also sealed as a result of the typical polyethylene coating being melted as the curl is flattened.

Two apparatus are commonly used to curl and flatten the upper edges of paperboard containers. These apparatus include a two-machine apparatus and a single machine apparatus. A conventional two-machine apparatus generally includes a pocket having an upper perimeter bounded by a concave groove or semi-spherical groove and a die ring having an opposing concave or semi-spherical groove. To curl the rim, the die ring is linearly moved towards the pocket so as to deform and curl the upper edge of the paperboard container. The paperboard container is then removed and loaded on to a second flattening machine having a pocket bounded by a flat surface and having a die ring providing an opposing flat surface. The die ring is linearly moved towards the flat surface of the pocket to flatten the curl therebetween. Although conventional, this two-machine apparatus is expensive, space consuming and slow.

A conventional single machine employs a pocket and a die ring similar to the pocket and die ring employed by the two-machine process for curling the upper edge of the paperboard container. However, instead of requiring that the paperboard container with a curled rim be removed and reloaded on a separate machine for flattening, the single machine lifts the container out of the pocket as four flattening anvils are extended towards one another and about the container under the rim to form a solid ring. A generally flat member is then moved against the anvils to compress and flatten the curled rim therebetween. The order of operation is then reversed to discharge the cup. Although eliminating the need for two separate machines to curl and flatten the paperboard upper edge, such single machine apparatus are still slow since the flattening step requires that the cup be raised and lowered relative to the pocket and also requires that four flattening anvils be extended toward the rim and retracted away from the rim. These additional steps increase process time and costs.

### SUMMARY OF THE INVENTION

One embodiment of the invention relates to an apparatus for forming a rim of a paperboard container having a bottom and a sidewall terminating at a rim. The apparatus includes a pocket including a shell having a cavity with a mouth configured to receive the container along an axis. The pocket further includes a first member about the cavity and including a first surface, and a second member including a second surface. The first surface is one of a flat surface and a concave surface and is actuatable along the axis from a retracted position below the mouth to an extended position adjacent to the mouth. The second surface is one of the flat surface and the concave surface. The second member is actuatable along the axis towards the first member so as to engage and form the paperboard rim between the first surface and the second surface.

Another embodiment of the invention relates to a machine for curling and flattening a rim of a paperboard container having a bottom and a sidewall terminating at a rim. The machine includes a frame, a turret rotatably coupled to the frame, a plurality of circumferentially spaced pockets supported by the turret, and a plurality of workstations about the turret. Each pocket includes a shell having a cavity with a mouth configured to receive the container along an axis. Each pocket further includes a first member about the cavity and including a first surface. The first surface is one of a flat surface and a concave surface and is actuatable along the axis from a retracted position below the mouth to an extended position adjacent the mouth. The plurality of workstations includes a first station and a second station. The first station includes a first tool having a second surface, wherein the second surface is the said one of a flat surface and a concave surface. The first tool is adapted to move along the axis so as to engage and form the paperboard rim between the first and second surfaces. The second station includes a second tool having a third surface. The third surface is the other of a flat surface and a concave surface. The second tool is adapted to move along the axis towards the paperboard rim. The second station further includes a plurality of die segments about the second tool. Each segment has a fourth surface, wherein the fourth surface is the other of a flat surface and a concave surface. The die segments are adapted to move along the axis and to pivot between a closed position in which the fourth surface engages and forms the rim and an open position.

Another embodiment of the invention relates to a method for forming a rim of a paperboard including a bottom and a sidewall terminating at a rim. The method includes positioning the container in a pocket having a mouth such that the rim extends beyond the mouth and such that the container is centered along an axis, actuating a first surface extending below and about the mouth towards the mouth and actuating a second surface towards the first surface so as to form the rim therebetween.

### BRIEF DESCRIPTION OF THE DRAWINGS

FIG. 1 is a top elevational view of a rim-forming apparatus of the present invention including a turret supporting a plurality of pockets, a heating station, a curling station, and a flattening station.

FIG. 2 is a side elevational view of a pocket of the apparatus of FIG. 1 taken along line 2-2.

FIG. 3 is a sectional view of the pocket of FIG. 2 taken along line 3-3.

FIG. 4 is an enlarged fragmentary sectional view of a container positioned within the pocket of FIG. 3.

FIG. 5 is a sectional view of the heating station of FIG. 1 taken along line 5-5.

FIG. 6A is a sectional view of the heating station of FIG. 5 taken along line 6A-6A illustrating a cam and a cam follower in a first position.

FIG. 6B is a sectional view of the heater of FIG. 5 taken along line 6A-6A illustrating the cam and cam follower in a second position.

FIG. 7 is an enlarged fragmentary sectional view of the heating station of FIG. 1 taken along line 5-5.

FIG. 8A is an enlarged fragmentary sectional view of the heating station of FIG. 1 in a retracted position relative to a pocket.

FIG. 8B is an enlarged fragmentary sectional view of the heating station of FIG. 1 in an extended position in which the heating station receives the container carried within a pocket.

FIG. 9 is an enlarged fragmentary sectional view of the curling station of FIG. 1 taken along line 9-9.

FIG. 10 is a side elevational view of the curling station of FIG. 9 taken along line 10-10.

FIG. 11A is an enlarged fragmentary sectional view of forming members of the curling station in an open position and retracted away from a container positioned within a pocket.

FIG. 11B illustrates the forming members of the curling station of FIG. 11 in an open position and extended into engagement with the container in the pocket.

FIG. 11C illustrates the forming members of the curling station of FIG. 11A in a closed position while curling a rim of the container positioned within the pocket.

FIG. 12 is an enlarged fragmentary sectional view of the flattening station of FIG. 1 taken along line 12-12.

FIG. 13 is a sectional view of the flattening station of FIG. 12 taken along line 13-13.

FIG. 14 is a sectional view of flattening station of FIG. 12 taken along line 14-14.

FIG. 15 is a side elevational view of the flattening station of FIG. 12 taken along line 15-15, with portions of the pocket omitted for purposes of illustration.

FIG. 16A is an enlarged fragmentary sectional view of a pocket of the machine of FIG. 1 supporting a container having a curled rim, wherein the forming member of the pocket is in a retracted position.

FIG. 16B illustrates the pocket and container of FIG. 16A after the pocket and container are positioned across the flattening station of FIG. 1 and after the forming member has been moved to an extended position even with the mouth of the pocket.

FIG. 16C illustrates the pocket and container of FIG. 16B after a forming member of the flattening station has been actuated towards the pocket so as to compress and flatten the curled rim between the forming member of the pocket and the forming member of the flattening station.

FIG. 17 is a fragmentary sectional view of the resulting container worked upon by the apparatus of FIGS. 1-16 and including a curled and flattened rim.

### DETAILED DESCRIPTION OF THE PREFERRED EMBODIMENTS

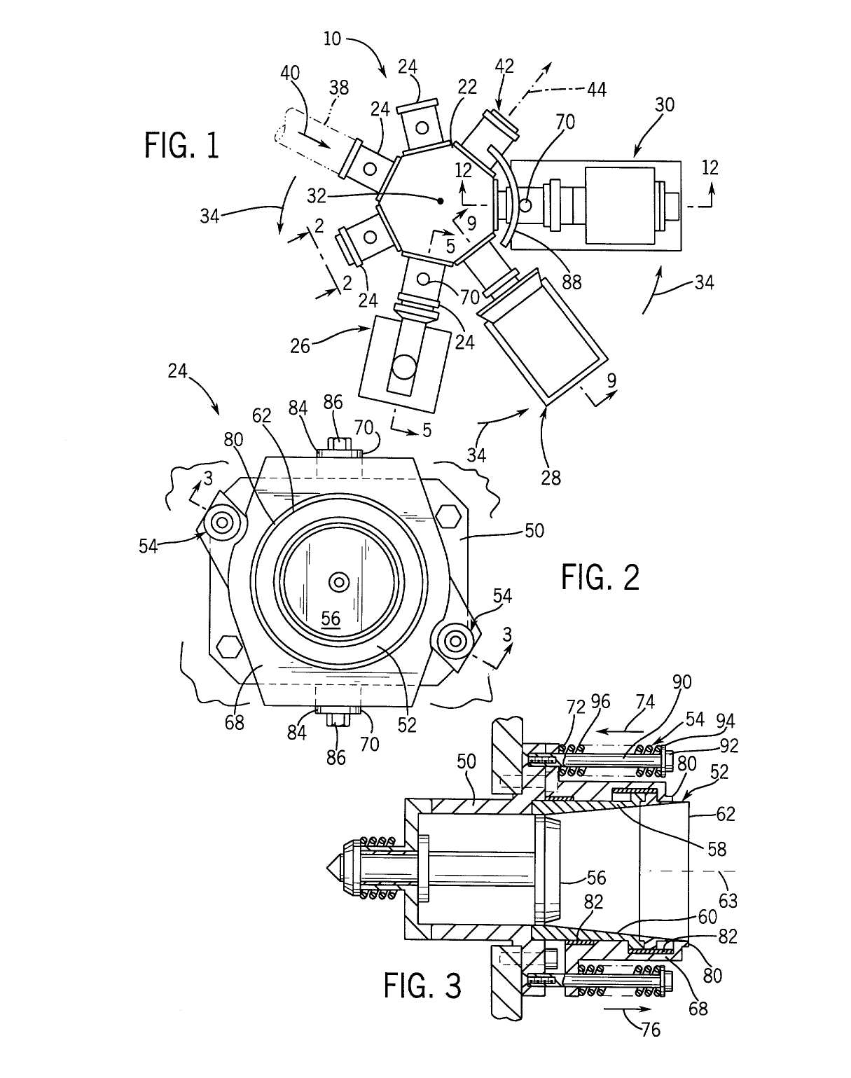

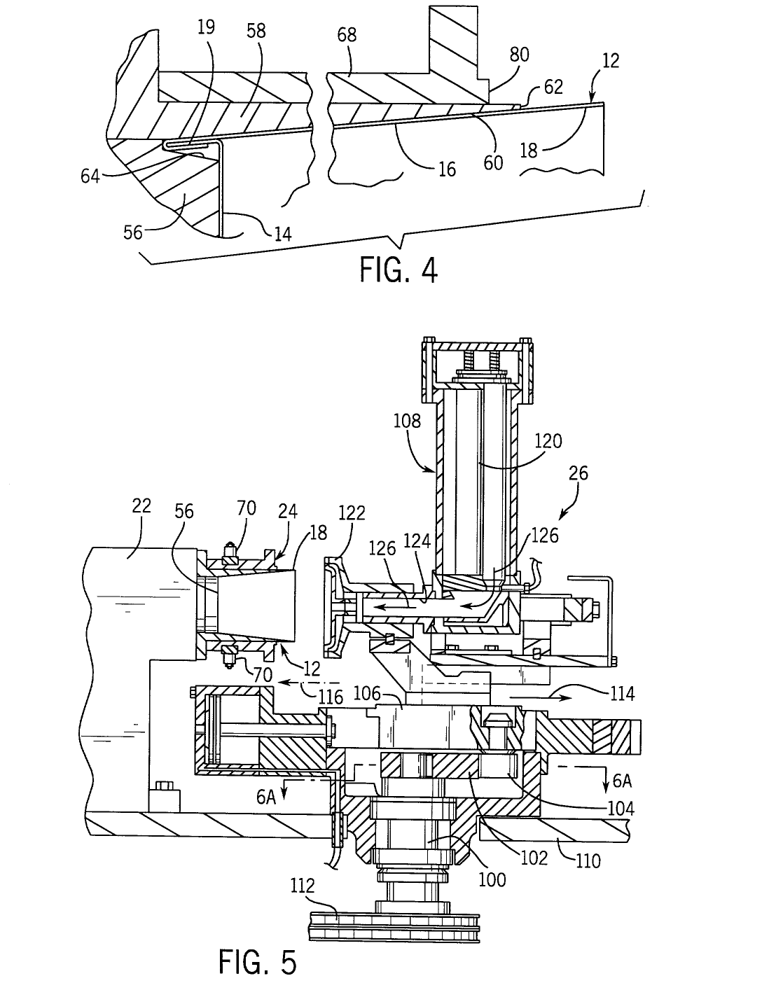

FIG. 1 is a top elevational view of paperboard rim forming apparatus 10 forming the rim of a paperboard container 12 (shown in FIG. 4) having a bottom 14 and a sidewall 16 terminating at a rim 18. Apparatus 10 generally includes turret 22, pockets 24, heating station 26, curling station 28, and flattening station 30. Turret 22 is conventionally known and is rotatably driven about axis 32 in the direction indicated by arrows 34 in a conventionally known manner to index and position pockets 24 sequentially between each of stations 26, 28 and 30.

Pockets 24 are coupled to turret 22 so as to be rotatably driven about axis 32 by turret 22. In the exemplary embodiment, apparatus 10 includes seven pockets 24 circumferentially and equidistantly spaced about turret 22. Alternatively, apparatus 10 may be provided with any of a number of pockets 24 depending upon the number of stations required to form rim 18 of container 12 as well as to possibly form additional portions of container 12. Pockets 24 are each configured to receive and carry an individual container 12 as apparatus 10 is forming container 12. In addition, each of pockets 24 is configured to assist in the forming of rim 18 of container 12 by providing at least one forming surface as will be described in greater detail thereafter. As a result, rim 18 of container 12 may be formed in fewer steps, in less time and with simpler and less expensive equipment.

Heating station 26, curling station 28 and flattening station 30 are circumferentially positioned about turret 22 and pockets 24 and are configured to engage rim 18 of container 12 to form rim 18. In operation, containers 12 having unformed rims 18 are individually loaded into pockets 24 at loading station 38, as indicated by arrow 34. Turret 22 thereafter rotates to position container 12 across from heating station 26. Heating station 26 directs hot air at rim 18 to melt the polyethylene coating on rim 18, to render it more pliable for deformation and to allow the flattened rim to seal. Turret 22 then rotates to position pocket 24 and its container 12 across from curling station 28. Curling station 28 forms rim 18 by curling rim 18. Turret 22 then rotates to position pocket 24 and its container 12 across from flattening station 30. Flattening station 30 further forms the curled rim 18 by compressing and flattening rim 18. Thereafter, turret 22 rotates to position pocket 24 and formed container 12 at discharge station 42 where container 12 and its completed rim 18 are ejected or otherwise removed from apparatus 10 as indicated by arrow 44.

FIGS. 2-4 illustrate pockets 24 and the loading of container 12 into each pocket 24 in greater detail. As shown by FIGS. 2 and 3, each pocket 24 generally includes shell support 50, shell 52, and shell-forming mechanism 54. Shell support 50 mounts to turret 22 (shown in FIG. 1) and is configured for supporting shell 52 and shell-forming mechanism 54. As will be appreciated, the exact configuration of shell support 50 may vary depending upon the configuration of turret 22, of shell 52 and of shell-forming mechanism 54.

Shell 52 is supported by shell support 50 and includes bottom 56 and side wall 58 defining cavity 60. Cavity 60 forms a mouth 62 and is configured to receive container 12. As shown in FIG. 4, bottom 56 and sidewall 58 form an annular groove 64 configured to receive a lower bottom rim 19 of container 12. Alternatively, groove 64 may be omitted where container 12 lacks such a lower bottom rim 19. As further shown by FIG. 4, sidewall 58 has a length extending beyond bottom 56 such that when container 12 is positioned within cavity 60, rim 18 projects above or generally beyond mouth 62. Preferably, sidewall 58 should be configured such that rim 18 projects above mouth 62 by a sufficient distance for enabling rim 18 to be curled and flattened to produce the final container 12 shown in FIG. 17.

Shell-forming mechanism 54 extends adjacent to shell 52 and is configured to act upon container 12 within shell 52. Shell-forming mechanism 54 generally includes forming member 68, cam followers 70 and bias mechanism 72. Forming member 68 is movable or actuatable along axis 63 between a retracted position as indicated by arrow 74 on the upper half of FIG. 3 and an extended position as indicated by arrow 76 on a lower half of FIG. 3. Forming member 68 includes a forming surface 80 and is configured to act upon rim 18 of container 12 when forming member 68 is in the extended position. In the exemplary embodiment, forming member 68 slides along an exterior surface of shell 52 by means of bearing bushings 82. Alternatively, the movement of forming member 68 along axis 63 may be facilitated by other bearing mechanisms or movable supporting arrangements.

Cam followers 70 are fixedly coupled or integrally formed as part of forming member 68. In the exemplary embodiment, cam followers 70 comprise rollers 84 supported by shafts 86 extending from forming member 68. Alternatively, cam followers 70 may have other shapes and configurations. Cam followers 70 interact with cams 88 (schematically shown in FIG. 1) to actuate forming member 68 between the retracted and extended positions in response to rotation of turret 22.

Bias mechanism 72 is supported by shell support 50 and is operably coupled to forming member 68. Bias mechanism 54 is configured to resiliently bias the forming member 68 to the retracted position. In the exemplary embodiment, bias mechanism 54 generally includes bolt 90 having an enlarged head 92 against a washer 94 and compression spring 96. Bolt 90 is coupled to shell support 50 and shell 52 and supports spring 96. Spring 96 is captured between washer 94 and forming member 68. During movement of forming member 68 to the extended position (indicated by arrow 76) as a result of cam follower 70 riding upon cam 88, spring 96 is compressed. As turret 22 rotates away from station 30, spring 96 resiliently returns to its initial length maintaining cam follower 70 against cam 88 and returning forming member 68 to the retracted position as indicated by arrow 74. In lieu of employing a spring to bias forming member 68 to the retracted position, mechanism 54 may include a variety of other well-known springs or resilient biasing structures to bias forming member 68 towards the retracted position. Moreover, in alternative embodiments, mechanism 54 may alternatively be configured to bias forming member 68 towards the extended position where cam follower 70 and cam 88 are alternatively configured to actuate forming member 68 from the extended position to the retracted position.

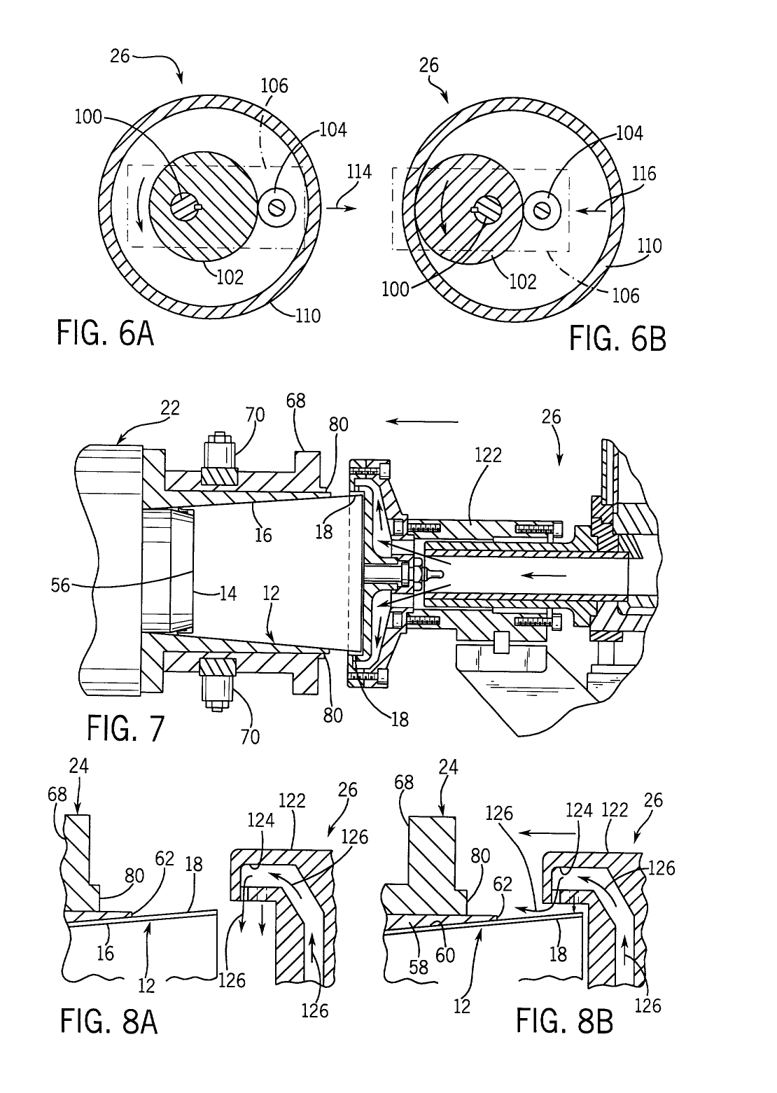

FIGS. 5-8 illustrate heating station 26 of apparatus 10 in greater detail. Heating station 26 is configured to heat rim 18 prior to rim 18 being formed in part by forming surface 80 (shown in FIG. 3). FIG. 5 illustrates turret 22 positioning pocket 24 carrying container 12 across from and opposite to heating station 26. As shown by FIG. 5, heating station 26 generally includes shaft 100, cam 102, cam follower 104, heater support 106 and heater assembly 108. Shaft 100 is rotatably supported within base 110 and is rotatably driven in the conventionally known manner by chains or belts 112. Shaft 100 is keyed to cam 102. Alternatively, shaft 100 is integrally formed as part of cam 102 or fixedly coupled to cam 102 by other means.

Cam 102 comprises a circular disk eccentrically mounted to shaft 100 and in engagement with cam follower 104. Rotation of cam 102 by shaft 100 engages cam follower 104 to reciprocate cam follower 104 and support 106 in the directions indicated by arrows 114 and 116.

Cam follower 104 is coupled to support 106 and interacts with cam 102 such that support 106 is reciprocally driven in the directions indicated by arrows 114 and 116 away from and towards pocket 24.

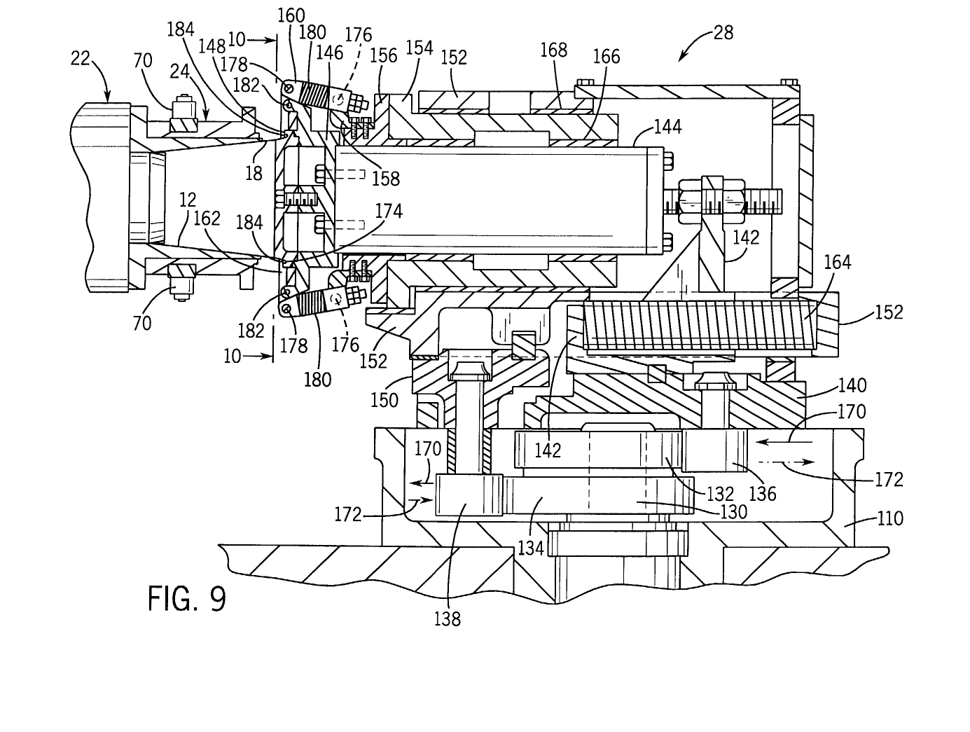

Heater assembly 108 is mounted upon support 106 and generally includes heater 120 and shroud 122. Heater 120 is conventionally known and is configured to heat surrounding air which is supplied by a compressor (not shown). The heated air is blown through the internal passageways 124 in the direction indicated by arrows 126 to shroud 122. As shown by FIGS. 7, 8A, and 8B, shroud 122 is configured to receive rim 18 of container 12 when pocket 24 is positioned opposite heater station 26 and when support 106 and heater assembly 108 have been reciprocated towards pocket 24. As best shown by FIGS. 8A and 8B, shroud 122 includes internal air passages 124 which direct the heated air from heater 120 onto rim 18 to melt the thermoplastic coating on the paperboard material forming rim 18 and render it more pliable so that it may be more easily curled at curling station 28 and may be sealed at flattening station 30.

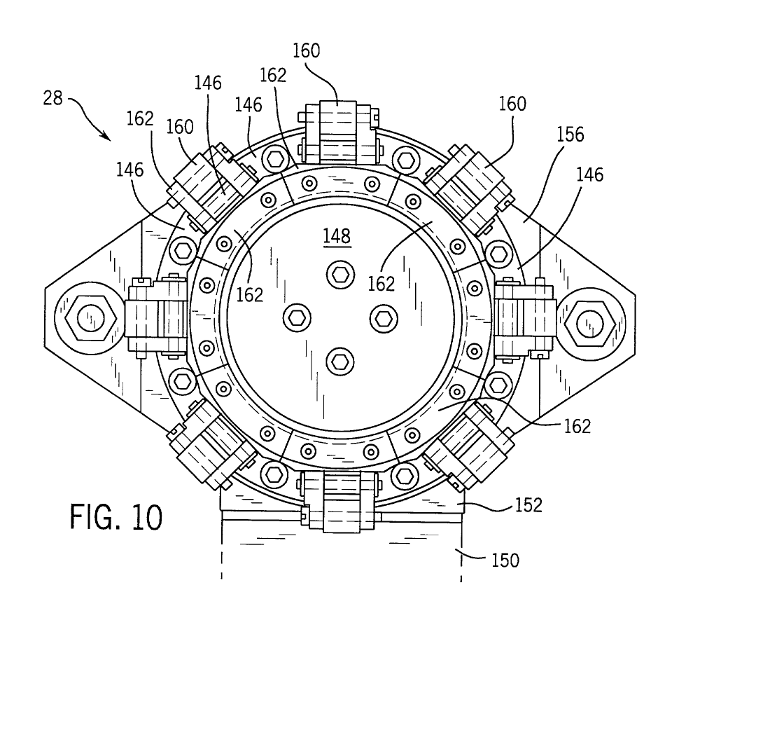

FIGS. 9-11 illustrate curling station 28 in greater detail. As best shown by FIGS. 9 and 10, curling station 28 generally includes drive shaft 130, cams 132, 134, cam followers 136, 138, inner supports 140, 142, 144, 146, forming member 148, outer supports 150, 152, 154, 156, 158, fingers 160, forming segments 162, spring 164 and bushings 166, 168. Shaft 130 is fixedly coupled to each of cams 132 and 134, and is rotatably driven by chains or belts in a conventionally known manner. Cams 132 and 134 are eccentrically mounted upon shaft 130 and interact with cam followers 136 and 138 to reciprocate cam followers 136 and 138 in the directions indicated by arrows 170 and 172 in a timed relationship with the rotation of turret 12, supporting pockets 24.

Cam follower 136 is coupled to inner support 140 which is in turn coupled to support 142. Support 142 is coupled to support 144 which is in turn coupled to support 146. Support 146 supports forming member 148. In the exemplary embodiment, support 140 is keyed to support 142. Support 142 is mounted to support 144. Support 144 comprises an elongate cylinder slidably supported by bushing 166 relative to outer support 154. Alternatively, each support 140, 142, 144 and 146 may be fixedly secured to one another by any of a variety of mounting mechanisms. Moreover, one or more of supports 140, 142, 144 and 146, as well as forming member 148, may alternatively be integrally formed with one another to reduce the number of parts or may be provided by a greater number of individual components secured to one another.

Forming member 148 is mounted to support member 146 and includes an annular forming surface 174 that generally faces pocket 24 when pocket 24 is opposite curling station 28. In the exemplary embodiment, forming surface 174 comprises a concave surface to facilitate curling of rim 18 of container 12. In one preferred embodiment, forming member 148 additionally includes a pancake heater (not shown) between forming member 148 and support 146. The pancake heater heats forming member 148 to better facilitate curling of rim 18 by forming surface 174. Although forming surface 174 preferably is annular in shape, forming surface 174 may alternatively have other continuous shapes depending upon the shape of the container and the rim being formed. For example, surface 174 may have noncircular shapes such as oval or general rectangular shapes.

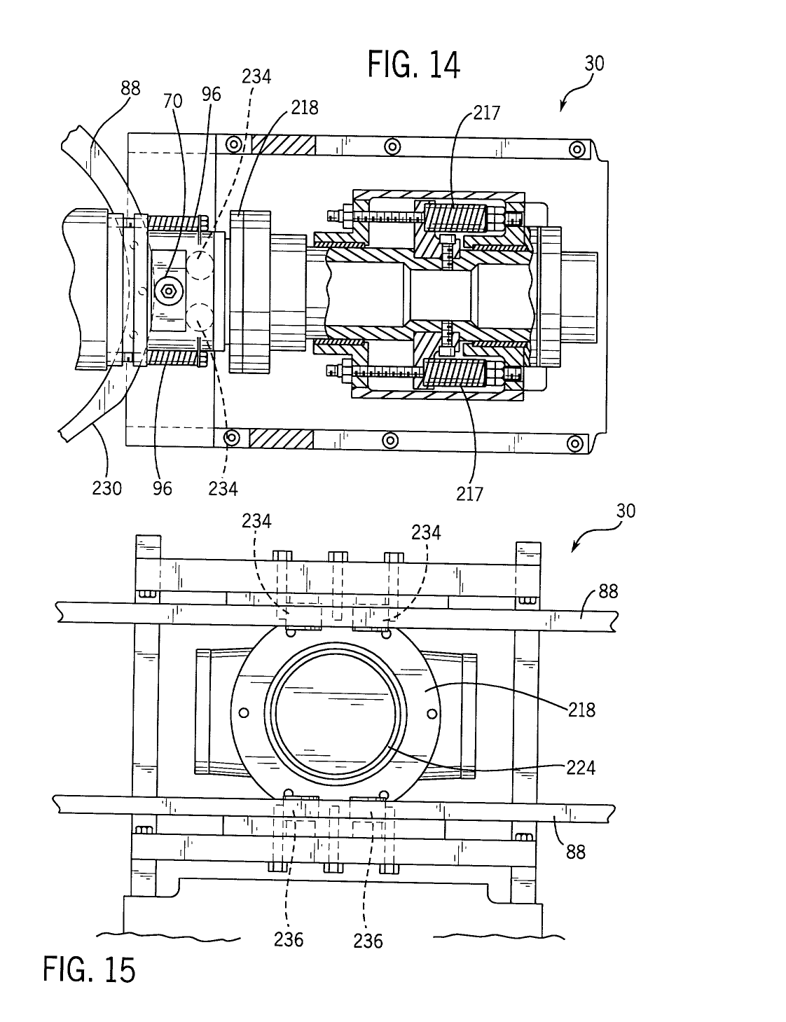

Cam follower 138 is rotatably coupled to support 150 which is coupled to support 152. Support 152 is coupled to support 154 which is coupled to support 156. Support 156 is pivotably coupled to each of fingers 160 which are in turn pivotably coupled to each of forming segments 162. Forming segments 162 are also pivotably coupled to support 146. As shown by FIG. 9, support 150 is preferably keyed to support 152. Support 152 comprises a general cylindrical shaped member coupled to support 154 by an intermediate bushing 168. Supports 152 and 154 are generally held stationary relative to one another by a pair of overload springs (not shown, but similar to overload springs 217 in FIG. 14) which are connected between supports 152 and 154. While encountering excessive loads, support 154 moves relative to support 152 against the force of the overload springs to compress the overload springs to prevent damage to curling station 28. As further shown by FIG. 9, support 152 cooperates with support 142 to capture compression spring 164 therebetween. Compression spring 164 acts against supports 142 and 152 to maintain cam followers 136 and 138 against cams 132 and 134, respectively, during rotation of shaft 130.

Fingers 160 extend between support 158 and forming segments 162 and are pivotably coupled to support 158 about axes 176 and also pivotably coupled to forming segments 162 about axes 178. As best shown by FIG. 10, fingers 160 encircle forming member 148. In the exemplary embodiment, curling station 28 includes eight such fingers 160 pivotably coupled to eight forming segments 162. As will be appreciated, the number of fingers and the number of forming segments may vary depending upon the size and configuration of the container being formed. Referring once again to FIG. 9, each finger 160 preferably has an adjustable length between pivot points 176 and 178 by means of two telescopically mating shafts, wherein the length is generally maintained by a spring 180. Compression spring 180 absorbs any excessive forces acting upon finger 160 to prevent undue damage to curling station 28.

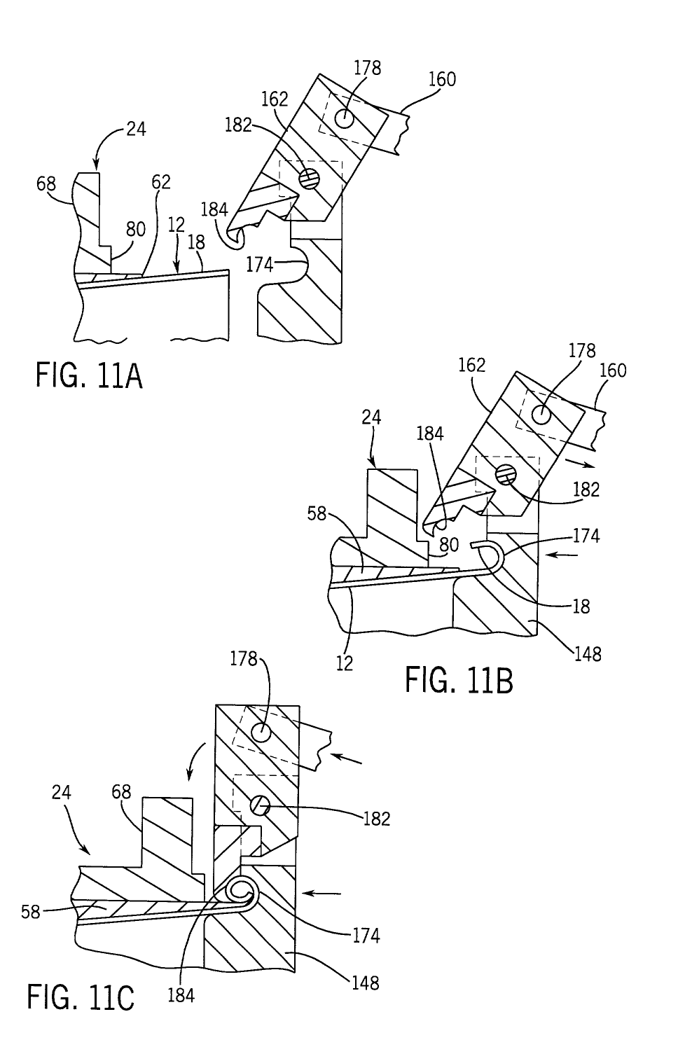

Each forming segment 162 comprises a generally arcuate segment having a forming surface 184. Forming segments 162 circumscribe generally the entire perimeter of forming member 148 and are pivotably coupled to fingers 160 about axes 178 and are further pivotably coupled to support member 146 about axes 182. Actuation of fingers 160 towards and away from pocket 24 by cam follower 138 pivots each of forming segments 162 in unison between an open position (shown in FIG. 11A) and a closed position (shown in FIG. 11C). In the closed position, each forming surface 184 generally faces the forming surface 174 to form rim 18 therebetween. In the exemplary embodiment, surfaces 174 and 184 are both concave so as to curl rim 18. In an alternative embodiment, surfaces 174 and 184 may be flat so as to alternatively flatten rim 18.

FIGS. 11A-11C illustrate the forming of rim 18 by surfaces 174 and 184 in greater detail. FIG. 11A illustrates finger 160 in a retracted position (i.e., pulled back in a direction away from pocket 24). As a result, forming segment 162 is pivoted about axis 182 to the open position. FIG. 11B illustrates forming member 148 being moved towards pocket 24 and into engagement with container 12 as a result of shaft 130 rotating cam 132 against cam follower 136. As a result, forming surface 174 forms rim 18 to partially curl rim 18. As shown by FIG. 11C, further rotation of shaft 130 continues to rotate cams 132 and 134 against cam followers 136 and 138, respectively, so as to move forming member 148 further towards pocket 24 and so as to also move fingers 160 towards pocket 24 such that forming segments 162 pivot to the closed position. As a result, forming surfaces 174 and 184 engage generally opposite sides of the partially curled rim 18 to completely curl rim 18 approximately 360 degrees. Thereafter, continued rotation of shaft 130 rotates cams 132 and 134 against cam followers 136 and 138, respectively, such that forming member 148 is withdrawn away from pocket 24 and such that fingers 160 are also withdrawn away from pocket 24. As a result, forming segments 162 are once again pivoted to the open position away from pocket 24, whereby curling station 28 is ready to once again form a successive container 12 appropriately positioned opposite curling station 28.

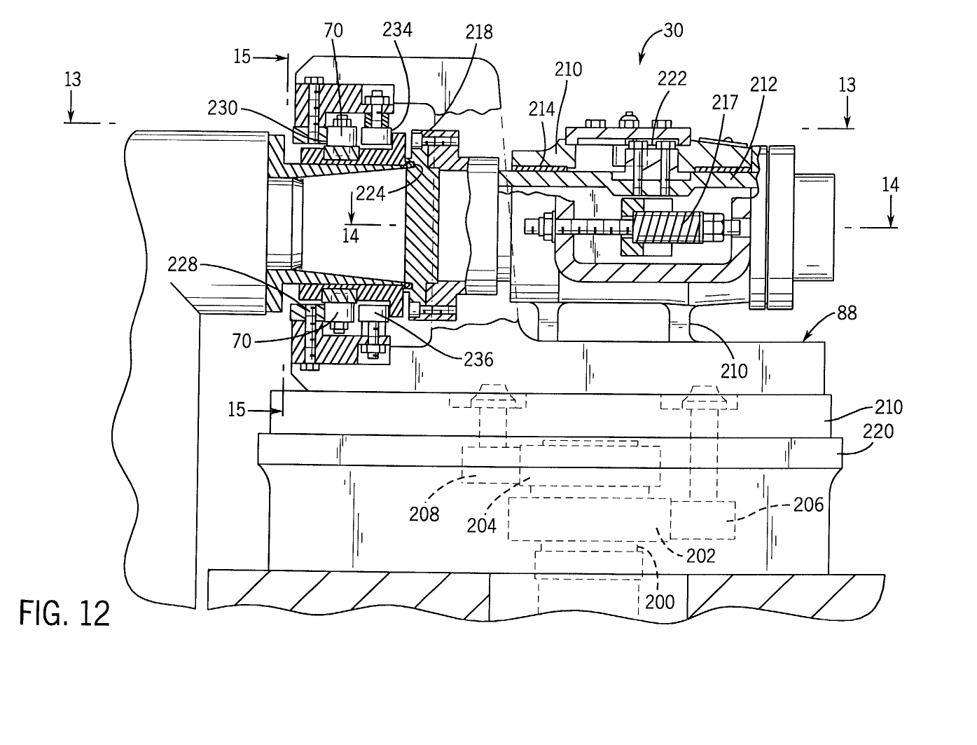

FIGS. 12-16 illustrate flattening station 30 in greater detail. As best shown by FIGS. 12-15, flattening station 30 generally includes shaft 200, cams 202, 204, cam followers 206, 208, support 210, support 212, bushing bearings 214, guide rollers 216, and forming member 218. Drive shaft 200 comprises a shaft, keyed or otherwise fixedly coupled to cams 202 and 204. Upon being driven in a conventionally known manner by a chain or belt drive, shaft 200 rotatably drives cams 202 and 204. Cams 202 and 204 are eccentrically mounted upon shaft 200 and act upon cam followers 206 and 208, respectively. Cam followers 206 and 208 are each rotatably coupled to support 210 which is slidably supported relative to base 220. Rotation of shaft 200 rotates cams 202, 204 which act upon cam followers 206 and 208 to reciprocate support 210 towards and away from turret 22 and pockets 24 in a timed manner.

Supports 210 comprises a general framework substantially surrounding support 212 and coupled to support 212 via bushings 214 and via overload compression springs 217. Overload compression springs 217 are positioned between support 210 and support 212 and have a predetermined spring constant such that supports 210 and 212 simultaneously move towards and away from turret 22 and pockets 24. However, upon encountering large unintended forces, forming member 218 and support 212 move relative to support 210 while compressing springs 217 to prevent excessive damage to flattening station 30. In those occurrences where support 212 encounters such large forces so as to move relative to support 210, guide rollers 216 extending from support 210 engage an upwardly projecting portion 222 of support 212 to maintain alignment of supports 210 and 212.

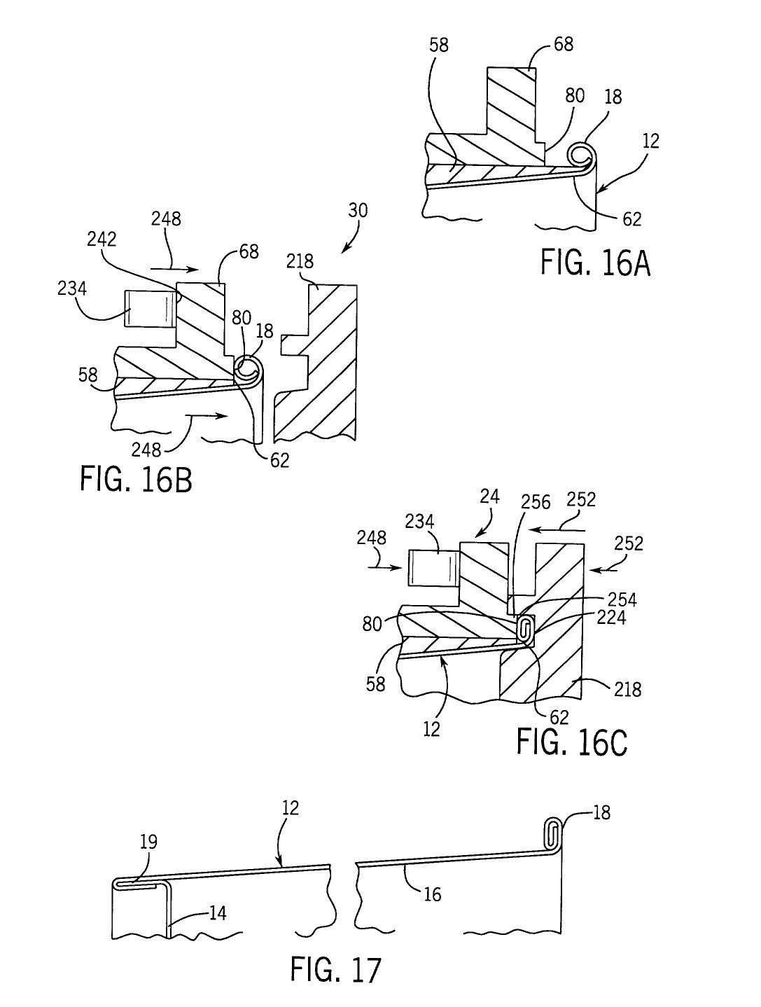

Forming member 218 is mounted to support 210 opposite turret 22 and pockets 24. Forming member 218 generally comprises a plate-like member providing forming surface 224. Forming surface 224 generally comprises an annular flat surface at a bottom of a groove 254 (shown in FIGS. 16B and 16C). Alternatively, forming surface 224 may have other continuous non-circular shapes depending upon the outer perimeter of the rim of the container being formed. Moreover, in applications where forming member 68 of pocket 24 has a concave forming surface 80, forming member 218 may alternatively have a concave forming surface 224 so as to curl the rim of a container.

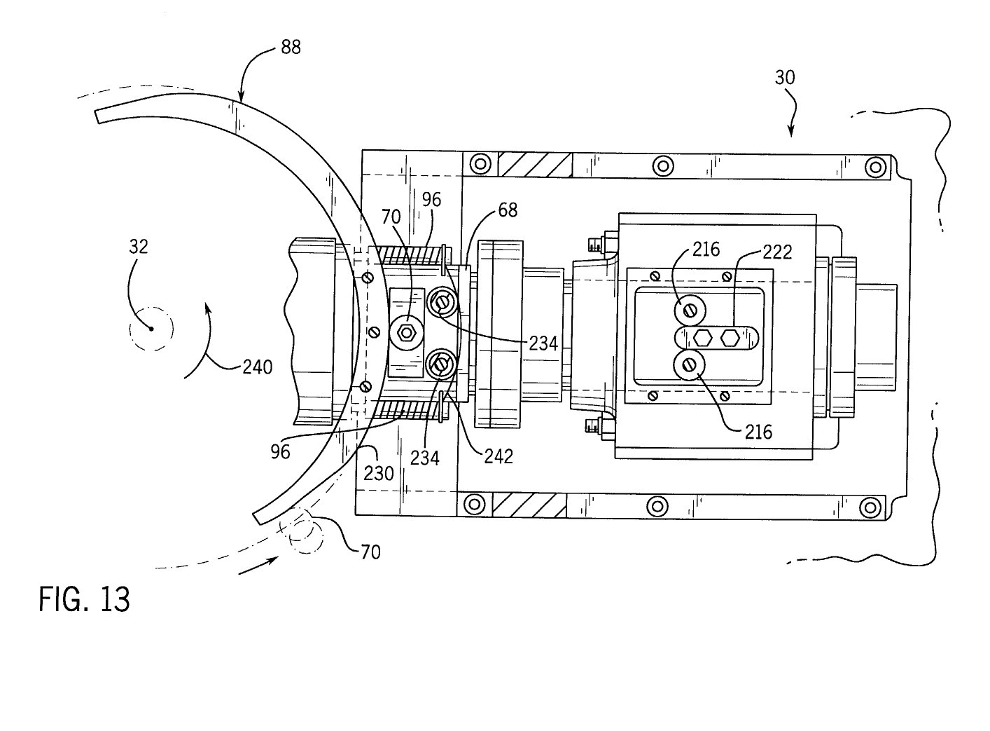

FIG. 12 further illustrates cam 88 in greater detail. Cam 88 generally comprises a rigid structure fixedly mounted to base 220 and providing cam surfaces against which cam followers 70 of pockets 24 bear against when being positioned across from flattening station 30. In particular, cam 88 includes lower cam surface 228 and upper cam surface 230 which are supported below and above pockets 24, respectively. Cam 88 additionally includes upper support rollers 234 and lower support rollers 236. Rollers 234 and 236 are rotatably supported above and below pockets 24 between cam surfaces 228 and 230 and forming member 218. As best shown by FIG. 13, as pocket 24 is being rotated about axis 32 in the direction indicated by arrow 240, cam followers 70 of pocket 24 are brought into engagement with cam surfaces 228 (shown in FIG. 12) and 230. Cam surfaces 228 and 230 act upon cam followers 70 to force cam followers 70 and forming member 68 radially away from axis 32 outwardly towards flattening station 30. As further shown by FIG. 13, forming member 68 includes arcuate shoulders 242 which ride upon and bear against support rollers 234 and 236 when forming member 68 has been moved to the extended position as previously discussed with respect to FIG. 3. As a result, the four support rollers 234, 236 support and bear against forming member 68 to transmit the forces from forming member 68 to cam 88 and to base 220 when forming member 218 is extended into engagement with rim 18 opposite forming member 68.

FIGS. 16A, 16B, and 16C illustrate the movement of forming members 68 and 218 to flatten curled rim 18. FIG. 16A illustrates curled rim 18 of container 12 positioned within pocket 24 after rim 18 has been curled at curling station 28 and prior to the positioning of pocket 24 opposite to flattening station 30. FIG. 16B illustrates pocket 24 and forming member 218 after turret 22 has rotated pocket 24 in position opposite flattening station 30. As indicated by arrows 248, cam surfaces 228 and 230 (shown in FIG. 12) engage cam followers 70 of pocket 24 to force forming member 68 radially outward towards forming member 218. As shown by FIG. 16B, forming member 68 is moved towards forming member 218 to an extent such that shoulder 242 bears against support roller 234 and support roller 236 (not shown) and such that forming surface 80 projects at least adjacent to and preferably even with mouth 62 in engagement with or in at least close proximity to an underside of curled rim 18.

As shown in FIG. 16C, continued rotation of shaft 200 (shown in FIG. 12) actuates supports 210, 212 and forming member 218 towards pocket 24 in the direction indicated by arrows 252 such that forming surface 224 engages an upper side of curled rim 18 and such that the groove 254, providing surface 224, receives the projection 256. As a result, rim 18 is captured between surfaces 80 and 224 within groove 254 and is compressed or flattened. Afterwards, continued rotation of shaft 200 retracts forming member 218 away from pocket 24 and turret 22 rotates pocket 24 to the next station, thereby positioning the next successive pocket carrying the curled, but unflattened rim 18 across from flattening station 30.

FIG. 17 is a fragmentary sectional view of container 12 after its rim 18 has been curled and flattened by apparatus 10. As best shown by FIG. 17, flattening station 30 compresses and flattens rim 18 such that rim 18 is generally flat along both its upper and lower surfaces. Because rim 18 is not only flattened on both sides, but is also compressed, any step along the seam of the paperboard material forming rim 18 is minimized. As a result, the seal between the sealing panel typically positioned across the opening of container 12 and sealed to the flat upper surface of rim 18 is more reliable and less susceptible to leakage.

Overall, apparatus 10 curls and flattens the edges of paperboard containers more quickly and at a lower cost as compared to known conventional devices. First, apparatus 10 does not require two separate machines for curling and flattening the rim. Second, apparatus 10 does not require that the container be pushed out of the pocket or that anvils be positioned about the container for the flattening step. This is partially facilitated by pocket 24 including forming member 68 and by a single reciprocating member providing both forming surfaces 174 and 184, wherein each of a plurality of forming segments 162 pivots to curl rim 18 between surfaces 174 and 184.

Although the present invention has been described with reference to preferred embodiments, workers skilled in the art will recognize that changes may be made in form and detail without departing from the spirit and scope of the invention. For example, although heater assembly 108 and each of forming members 68, 148, 162 and 218 are illustrated and described as being actuated by means of cam and cam follower arrangements, such structures or members may alternatively be actuated by other well-known actuation mechanisms such as solenoids, hydraulic cylinders or pneumatic cylinders operated under the control of sensors and one or more programmed logic controllers or other control devices. In lieu of forming member 68 moving towards mouth 62 of shell 52 to flatten curled rim 18, apparatus 10 may alternatively be configured such that shell 52 retracts relative to a stationary forming member 68, whereby member 68 extends above mouth 62 of shell 52. In lieu of heater assembly 108 and forming members 148 and 218 being actuated or moved towards pockets 24 and turret 22, apparatus 10 may alternatively be configured such that pockets 24 are alternatively actuated or moved towards a stationary heater assembly 108, a stationary forming member 148 and a stationary forming member 218 or may be configured such that pockets 24 and one or more of heater assembly 108, forming member 148 and forming member 218 are both moved or actuated towards one another by cams, solenoids, cylinder-piston assemblies or other actuation mechanisms. These and other reversal of components and actuation directions are contemplated within the present disclosure. In addition, although apparatus 10 is illustrated as including flat and concave surfaces which act upon rim 18 to form rim 18, apparatus 10 may be provided with alternative differently shaped surfaces depending upon the desired resulting shape of rim 18. Although different preferred embodiments may have been described as including one or more features providing one or more benefits, it is contemplated that the described features may be interchanged with one another or alternatively be combined with one another in the described preferred embodiments or in other alternative embodiments. Because the technology of the present invention is relatively complex, not all changes in the technology are foreseeable. The present invention described with reference to the preferred embodiments and set forth in the following claims is manifestly intended to be as broad as possible. For example, unless specifically otherwise noted, the claims reciting a single particular element also encompass a plurality of such particular elements.

What is claimed is:

1. An apparatus for forming a rim of a paperboard container having a bottom and a side wall terminating at a rim, the apparatus comprising:
a pocket including:
a shell having a cavity with a mouth configured to receive the container along an axis; and
a first member about the cavity and including a first surface, the first surface being one of a flat surface and a concave surface, the first member being actuatable along the axis from a retracted position below the mouth to an extended position adjacent the mouth; and
a second member including a second surface, the second surface being said one of a flat surface and a concave surface, the second member being actuatable along the axis towards the first member so as to engage and form the paperboard rim between the first surface and the second surface.

2. The apparatus of claim 1, wherein the first surface is a flat surface, wherein the second surface is a flat surface and wherein the first and second surfaces compress and flatten the paperboard rim therebetween.

3. The apparatus of claim 1 including a station including:
a forming tool having a third surface, the third surface being the other of a flat surface and a concave surface, the forming tool configured to move along the axis so as to engage and form the rim of the paperboard container; and
a plurality of die segments about the forming tool, each segment having a fourth surface, the fourth surface being the other of the flat surface and the concave surface, wherein the die segments are adapted to move along the axis and to pivot between a closed position in which the fourth surface engages the rim to form the rim between the third and fourth surfaces and an open position.

4. The apparatus of claim 3, wherein the third surface is a concave surface and wherein the fourth surface is a concave surface such that the third and fourth surfaces curl the rim.

5. The apparatus of claim 1 including a heating station configured to heat the rim prior to the rim being formed between the first member and the second member.

6. A machine for curling and flattening a rim of a paperboard container having a bottom and a sidewall terminating at a rim, the machine comprising:
a frame;
a turret rotatably coupled to the frame;
a plurality of circumferentially spaced pockets supported by the turret, each pocket including:
a shell having a cavity with a mouth configured to receive the container along an axis; and
a first member about the cavity and including a first surface, the first surface being one of a flat surface and a concave surface, the first member being actuatable along the axis from a retracted position below the mouth to an extended position adjacent the mouth; and
a plurality of work stations about the turret, the work stations including:
a first station including a first tool having a second surface, the second surface being said one of a flat surface and a concave surface, the first tool being adapted to move along the axis so as to engage and form the paperboard rim between the first and second surfaces; and
a second station including:
a second tool having a third surface, the third surface being the other of a flat surface and a concave surface, the second tool being adapted to move along the axis towards the paperboard rim; and
a plurality of die segments about the second tool, each segment having a fourth surface, the fourth surface being the other of a flat surface and a concave surface, wherein the die segments are adapted to move along the axis and to pivot between a closed position in which the fourth surface engages and forms the rim and an open position.

7. The machine of claim 6, wherein the first and second surfaces are flat surfaces so as to flatten and compress the rim therebetween.

8. The machine of claim 7, wherein the turret is adapted to position the pocket in the paperboard container adjacent the first station prior to positioning the paperboard container adjacent the second station such that the rim is first curled and is then flattened.

9. The machine of claim 8, including a heating station configured to heat the rim prior to the turret positioning the rim adjacent the first station.

10. A method for forming a rim of a paperboard container including a bottom and a sidewall terminating at a rim, the method comprising:
positioning the container in a pocket having a mouth such that the rim extends beyond the mouth and such that the container is centered along an axis;
actuating a first surface extending below and about the mouth towards the mouth; and
actuating a second surface towards the first flat surface so as to form the rim therebetween.

11. The method of claim 10, wherein the first surface and the second surface are flat.

12. The method of claim 11, including:
moving a third concave surface along the axis in engagement with the rim to initiate forming of the rim; and
moving a fourth concave surface along the axis; and
pivoting the fourth concave surface into engagement with the rim such that the third concave surface and the fourth concave surface cooperate to form the rim therebetween.

13. The method of claim 10, including:
moving a third surface along the axis in engagement with the rim to initiate forming of the rim; and
moving a fourth surface along the axis; and
pivoting the fourth surface into engagement with the rim such that the third surface and the fourth surface cooperate to form the rim therebetween.

14. The method of claim 10, including heating the rim prior to forming the rim.
